(19) United States
(12) Patent Application Publication
(10) Pub. No.: US 2025/0332511 A1
(43) Pub. Date: Oct. 30, 2025

(54) METHOD AND APPARATUS FOR DISPLAYING GAME SCENE, AND ELECTRONIC DEVICE AND STORAGE MEDIUM

(71) Applicant: NETEASE (HANGZHOU) NETWORK CO., LTD., Hangzhou, Zhejiang (CN)

(72) Inventors: Mengqiao XIONG, Hangzhou, Zhejiang (CN); Chengye WU, Hangzhou, Zhejiang (CN)

(73) Assignee: NETEASE (HANGZHOU) NETWORK CO., LTD., Hangzhou, Zhejiang (CN)

(21) Appl. No.: 18/555,885

(22) PCT Filed: Sep. 24, 2021
(86) PCT No.: PCT/CN2021/120415

§ 371 Date: Mar. 12, 2025

(30) Foreign Application Priority Data
Apr. 20, 2021 (CN) 202110425285.3

(51) Int. Cl. A63F 13/57; A63F 13/52; A63F 13/533

(52) U.S. Cl. CPC A63F 13/57; A63F 13/52; A63F 13/533; A63F 2300/663

(57) ABSTRACT

The method for displaying a game scene includes: acquiring weather configuration information for the game scene, and setting a target weather for the game scene according to the weather configuration information; acquiring a deformation parameter of a target virtual object in the game scene under the target weather; and adjusting a rendering parameter of the target virtual object according to the deformation parameter, thereby controlling the target virtual object to deform in the game scene.

### CROSS REFERENCE TO RELATED APPLICATION(S)

The present disclosure claims the priority of the Chinese patent application No. 202110425285.3 with the title of “Method and Apparatus for Displaying Game, Electronic Device and Storage Medium” filed on Apr. 20, 2021, the entire content of which is incorporated herein by reference.

### TECHNICAL FIELD

The present disclosure relates to the technical field of games, and in particular to the method and apparatus for for displaying a game scene, and electronic device and storage medium.

### BACKGROUND

As the game development technology continues to become more sophisticated, gamers are increasingly proposing higher and higher requirements for the realism of game scenes. Realistic game scenes will enhance the play gaming experiences to a certain extent.

At present, for the special effects like rise and fall of the river water in the game scene under a sunny or rainy weather effect, the realistic effect is simulated by playing the water rising and falling animation.

However, because the animation is pre-drawn, the simulation effect is less realistic. Once the scene is modified, the animation needs to be changed accordingly, which increases cost and time-consuming for the game development.

### SUMMARY

The technical solutions adopted in embodiments of the present disclosure are as follows.

In a first aspect, embodiments of the present disclosure provide a method for displaying a game scene, including:
acquiring weather configuration information for the game scene, and setting a target weather for the game scene according to the weather configuration information;
acquiring a deformation parameter of a target virtual object in the game scene under the target weather; and
adjusting a rendering parameter of the target virtual object according to the deformation parameter, thereby controlling the target virtual object to deform in the game scene.

In a second aspect, embodiments of the present disclosure further provide an apparatus for displaying a game scene, including: a setting module, an acquisition module, and a control module. The setting module is configured to acquire weather configuration information for the game scene, and set a target weather for the game scene according to the weather configuration information. The acquisition module is configured to acquire a deformation parameter of the target virtual object in the game scene under the target weather. The control module is configured to adjust a rendering parameter of the target virtual object according to the deformation parameter, thereby controlling the target virtual object to deform in the game scene.

In a third aspect, embodiments of the present disclosure provide an electronic device, including: a processor, a storage medium, and a bus. The storage medium stores machine-readable instructions executable by the processor. When the electronic device is running, the processor and the storage medium communicate through the bus, and the processor executes the machine-readable instructions to perform steps of the method as provided in the first aspect.

In a fourth aspect, embodiments of the present disclosure provide a computer-readable storage medium. A computer program is stored on the storage medium. When run by a processor, the computer program performs steps of the method as provided in the first aspect.

### BRIEF DESCRIPTION OF THE DRAWINGS

In order to explain the technical solutions in embodiments of the present disclosure more clearly, the drawings needed to be used in the embodiments will be briefly introduced below. It should be understood that the following drawings only show some embodiments of the present disclosure, and therefore should not be regarded as a limitation of the protection scope. For those of ordinary skills in the art, other relevant drawings can be obtained based on these drawings without exerting creative efforts.

FIG. 1 is a schematic flowchart 1 of a method for displaying a game scene provided by an embodiment of the present disclosure;

FIG. 2 is a schematic flowchart 2 of a method for displaying a game scene provided by an embodiment of the present disclosure;

FIG. 3 is a schematic flowchart 3 of a method for displaying a game scene provided by an embodiment of the present disclosure;

FIG. 4 is a schematic flow chart 4 of a method for displaying a game scene provided by an embodiment of the present disclosure;

FIG. 5 is a schematic diagram of an apparatus for displaying a game scene provided by an embodiment of the present disclosure; and

FIG. 6 is a schematic structural diagram of an electronic device provided by an embodiment of the present disclosure.

### DETAILED DESCRIPTION OF THE EMBODIMENTS

In order to make the purpose, technical solutions, and advantages of embodiments of the present disclosure much clearer, the technical solutions in the embodiments of the present disclosure will be clearly and completely described below with reference to the accompanying drawings in the embodiments of the present disclosure. It should be understood that the drawings are only for illustration and description purposes, and are not intended to limit the protection scope of the present disclosure. Additionally, it should be understood that the schematic drawings are not drawn to scale. The flowcharts used in the present disclosure illustrate operations implemented in accordance with some embodiments of the present disclosure. It should be understood that the operations in the flowcharts may be implemented out of sequence, and steps not linked in a logical context may be implemented in a reverse order or simultaneously. In addition, those skilled in the art may add one or more other operations into the flowchart, and may also remove one or more operations from the flowchart, under the guidance by the present disclosure.

In addition, the described embodiments are only some, not all, of the embodiments of the present disclosure. The components in the embodiments of the present disclosure generally described and illustrated in the drawings herein may be arranged and designed in a variety of different configurations. Therefore, the following detailed description about the embodiments of the present disclosure provided in the appended drawings is not intended to limit the protection scope of the present disclosure as claimed, but rather to represent the selected embodiments of the present disclosure. Based on the embodiments of the present disclosure, all other embodiments obtained by those skilled in the art without any creative efforts shall fall within the protection scope of the present disclosure.

It should be noted that the term “comprising/comprise” will be used in the embodiments of the present disclosure to indicate the existence of the features stated subsequently, but does not exclude the addition of other features.

FIG. 1 is a schematic flowchart 1 of a method for displaying a game scene provided by an embodiment of the present disclosure. The execution subject of this method may be a terminal device or a server. When the execution subject is a terminal device, the terminal device may acquire weather configuration information from the server, and execute the method steps locally to control the deformation of the target virtual object. When the execution subject is a server, the server may execute the method steps locally, acquire the adjusted rendering parameter of the target virtual object and send it to the terminal device. Then, the terminal device may control the deformation of the target virtual object according to the received rendering parameter. As shown in FIG. 1, the method for displaying the game scene may include the following steps.

S101, the weather configuration information for the game scene is acquired, and the target weather for the game scene is set according to the weather configuration information.

First of all, it should be noted that the method according to the present disclosure may be applied to different games, so as to truly simulate the deformation effect of a virtual object in the game scene under different weather conditions in the game, thereby improving the realism of the game scene and the gaming experience for the game player.

Optionally, the weather configuration information may be preset according to the scene effect requirements for the game scene. The weather configuration information may be stored locally on the server. The server may determine the target weather for the game scene based on the stored weather configuration information, and notify the target weather for the game scene to the terminal device. In addition, the weather configuration information may also be stored locally on the terminal device, and the terminal device may determine the target weather for the game scene based on the weather configuration information. In addition, the weather configuration information may also be data captured by the terminal device from the weather application. The specific method for acquiring the weather configuration information is not limited to the above-mentioned methods.

The weather configuration information may be configured with triggering times for different weather conditions in the game scene. In this way, the target weather for the game scene may be determined based on the current time and the triggering times for different weather conditions.

S102, the deformation parameter is acquired of the target virtual object in the game scene under the target weather.

In some embodiments, the deformation parameters of different target virtual objects in the game scene are different under different weather conditions. That is, the weather and the deformation parameter of the virtual object are corresponding to each other, and the deformation parameter of each virtual object under each weather condition may be different. The deformation parameter may refer to a parameter used for controlling the form of the target virtual object to change in the game scene. The target virtual object may refer to a virtual building, a virtual prop, etc. in the game scene.

Optionally, the deformation parameter of the target virtual object in the game scene under the target weather may also be preset. It may be a parameter which is set after multiple simulations of the deformation of the target virtual object in the game scene under the target weather, so that the most realistic deformation effect is achieved of the target virtual object under the target weather and the deformation parameter.

S103, the rendering parameter of the target virtual object is adjusted according to the deformation parameter, thereby controlling the target virtual object to deform in the game scene.

Optionally, the initial rendering parameter of the target virtual object may be adjusted according to the acquired deformation parameter, thereby controlling the target virtual object to deform corresponding to the target weather for the game scene.

In an optional way, the rendering parameter of the target virtual object may be continuously adjusted according to the deformation parameter, so as to control the target virtual object to continuously deform from the initial form to the target form under the target weather, thereby simulating and realizing the realistic deformation effect of the target virtual object in the game scene.

In summary, the method for displaying a game scene provided by an embodiment of the present disclosure includes set of: acquiring the weather configuration information for the game scene, and setting the target weather for the game scene according to the weather configuration information; acquiring the deformation parameter of the target virtual object in the game scene under the target weather; and adjusting the rendering parameter of the target virtual object according to the deformation parameter, thereby controlling the target virtual object to deform in the game scene. According to this method, the deformation parameter is acquired of the target virtual object in the game scene under the target weather, and the rendering parameter of the target virtual object is adjusted according to the deformation parameter, thereby achieving the control over the deformation of the target virtual object under the target weather. Since the rendering parameter of the target virtual object may be adjusted in real time through the deformation parameter, the precise control over the deformation of the target virtual object can be achieved. This helps to achieve the true simulation of the deformation effect, enrich the performance of the game scene, and improve the player's gaming experience.

Optionally, in the above step S102, the acquisition of the deformation parameter of the target virtual object in the game scene under the target weather may include: acquiring the weather parameter of the target weather; and determining the deformation parameter according to the weather parameter, where the deformation parameter include the unit movement distance. The weather parameter may include: the weather duration and/or the weather measurement value.

Optionally, the weather duration may refer to the duration of a specific weather for the game scene. For example, if the target weather is rainfall, the weather duration may refer to the duration of rainfall, and the weather measurement value may refer to the occurrence level of a specific weather, for example, rainfall amount (or precipitation amount), wind level, etc.

The deformation parameter of the target virtual object under the target weather may be determined according to the weather parameter of the specific target weather. In an embodiment, the deformation parameter may include the unit movement distance, and the unit movement distance may refer to the unit movement distance of the target virtual object during the deformation process.

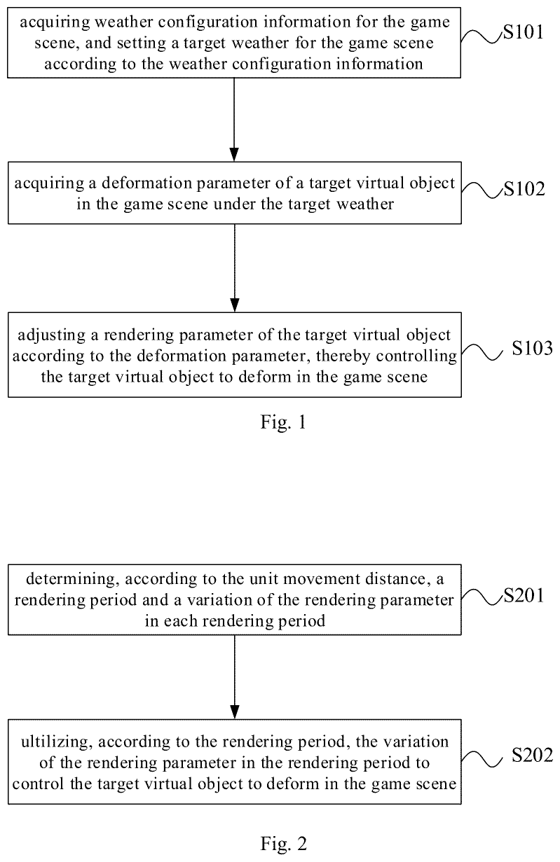

FIG. 2 is a schematic flowchart 2 of a method for displaying a game scene provided by an embodiment of the present disclosure. Optionally, the deformation parameter of the target virtual object in the game scene under the target weather may include the unit movement distance. In step S103, the adjustment of the rendering parameter of the target virtual object according to the deformation parameter, thereby controlling the target virtual object to deform in the game scene, may include the following contents.

S201, the rendering period and the variation of the rendering parameter in each rendering period are determined based on the unit movement distance.

Optionally, the unit movement distances corresponding to different target virtual objects may be different. According to the unit movement distance, the rendering period for the target virtual object and the variation of the rendering parameter of the target virtual object in each rendering period may be determined. In some cases, the variation of the rendering parameter in each rendering period may be the same. In some cases, the variation of the rendering parameter in each rendering period may be different. This is specifically determined according to the unit movement distance of the target virtual object in each rendering period.

S202, according to the rendering period, the variation of the rendering parameter in the rendering period is used for controlling the target virtual object to deform in the game scene.

Alternatively, the target virtual object may be controlled to deform step by step and period by period in the game scene according to the rendering period and the variation of the rendering parameter in each rendering period as determined above.

Assume that the rendering period includes four periods. The parameter variation in the first period is a, the parameter variation in the second period is b, the parameter variation in the third period is c, and the parameter variation in the fourth period is d. The initial rendering parameter is m. Then, according to the order of each period, the target virtual object may be controlled sequentially to change from the state corresponding to the initial rendering parameter m to the state corresponding to the rendering parameter mta, until it reaches the final deformation state corresponding to the parameter m+a+b+c+d. That is, each period is rendered sequentially, and the next rendering period is superimposed on the rendering result of the previous rendering period, thereby achieving the gradual control over the deformation of the target virtual object and showing a more realistic deformation process.

Optionally, the target virtual object in the above steps may include a first target virtual object. The method according to the present disclosure may further include: modifying the interaction parameter of the first target virtual object when the deformation of the first target virtual object reaches a preset threshold, thereby changing the interactable state of the first target virtual object.

In some embodiments, based on the realism of the deformation, there will be an upper limit for the deformation of any target virtual object, rather than an infinite deformation. When the deformation of the first target virtual object reaches a preset threshold, the interaction parameter of the first target virtual object may be modified, so as to change the interactable state of the first target virtual object. Here, the preset threshold may be considered as the limit value for the deformation of the first target virtual object under the target weather. The interaction here may refer to the interaction between the first target virtual object and other movable virtual objects, such as other virtual characters and virtual carriers, in the game scene.

Optionally, changing the interactable state of the first target virtual object may include: setting the first target virtual object as a passable area or an unpassable area.

In the present solution, the interactable state of the first target virtual object may include two types, where the first target virtual object is a passable area or an unpassable area. Changing the interactable state of the first target virtual object may comprise: changing the first target virtual object, that has been set as a passable area, to be an unpassable area, or changing the first target virtual object, that has been set as an unpassable area, to be a passable area.

When the first target virtual object is set as a passable area, other virtual characters, virtual carriers, etc. may be allowed to pass through the first target virtual object. When the first target virtual object is set as an unpassable area, other virtual characters, virtual carriers, etc. will not be able to pass through the first target virtual object.

Optionally, the above-mentioned target weather may include: a rainy day; the first target virtual object may be: a virtual river surface; and the variation of the rendering parameter may include: an altitude increment.

In some embodiments, when the current target weather is determined to be a rainy day according to the weather configuration information, and the first target virtual object is a virtual river surface in the game scene, then the unit movement distance of the virtual river surface under the rainy weather as determined may be used, for determining the rendering period of the virtual river surface under the rainy weather and the variation of the rendering parameter in each rendering period. Optionally, the variation of the rendering parameter in each rendering period may be the altitude increment of the virtual river surface.

Usually, on rainy days, the virtual river surface in the game scene will slowly rise as the rain continues to fall. That is, the altitude of the virtual river surface is constantly increasing.

In an optional way, when the rain intensity is uniform, the determined altitude increment in each rendering period may be equal, thereby controlling the virtual river surface to slowly increase, as the rain continues, according to the altitude increment in each rendering period.

In another optional way, when the rain intensity is uneven, the determined altitude increment in each rendering period may be unequal, and the altitude increment in each rendering period under different rain intensities may be determined according to the magnitude of the respective rain intensity. When the rain is heavy, the virtual river surface will rise slightly faster, and the altitude increment in the respective rendering period is relatively large. When the rain is light, the virtual river surface will rise slightly slower, and the altitude increment in the respective rendering period is relatively small. Therefore, the initial rendering parameter of the virtual river surface may be adjusted according to each rendering period based on the determined altitude increment in each rendering period, so that the virtual river surface is controlled to produce a realistic deformation corresponding to rainy days. The initial rendering parameter may be the altitude of the virtual river surface on a sunny day.

Optionally, the method according to the present disclosure may further include: if the current deformation of the first target virtual object reaches the first preset threshold, controlling the first target virtual object to maintain the current deformation unchanged.

In some embodiments, in order to ensure the realism of the deformation of the target virtual object, there will be a maximum value of the deformation, that is, a first preset threshold. When the current deformation of the first target virtual object reaches the first preset threshold, the first target virtual object may be controlled to stop deformation, that is, maintaining the current deformation unchanged. For example, on rainy days, the virtual river surface will stop rising after it reaches a certain height, instead of rising infinitely. Then, when the virtual river surface rises to a preset height, it will stop deforming.

Based on the occurrence of the above deformation, in the above steps, when the deformation of the first target virtual object reaches a preset threshold, the interaction parameter of the first target virtual object is modified, thereby changing the interactable state of the first target virtual object. This may include: after the deformation of the virtual river surface reaches a preset height, the interactable state of the virtual river surface is changed to be an unpassable area, thereby preventing virtual characters or virtual carriers from passing through the virtual river surface. That is to say, on rainy days, as the virtual river surface continues to rise, the virtual river surface is higher and higher. In this case, virtual characters or virtual carriers will not be able to pass through the virtual river surface. That is, the interactable state of the virtual river surface becomes an unpassable area.

Optionally, a virtual barrier model may be built in advance. After the deformation of the virtual river surface reaches a preset height, the virtual barrier model may be added onto the virtual river surface, so as to set the interactable state of the virtual river surface to be an unpassable area.

Optionally, in the above steps, the target weather may also include: a sunny day; the first target virtual object may be: a virtual river surface; and the variation of the rendering parameter may include: an altitude reduction.

Contrary to the above situation where the target weather is rainy, when the target weather is sunny, the variation of the rendering parameter may be the altitude reduction of the virtual river surface. That is, an effect is rendered where the water of the virtual river surface gradually recedes. Of course, the premise for this situation to occur is that before the sunny day, the target weather is a rainy day, and the virtual river surface has risen to the preset height. At this time, the virtual river surface may be controlled to slowly recede. When it was also sunny before, the virtual river surface did not change. In this case, since there was no obvious deformation effect, no detailed explanation will be given.

In some embodiments, the altitude reduction of the virtual river surface in each rendering period may be equal under the sunny weather, and the initial rendering parameter of the virtual river surface may be continuously adjusted according to the altitude reduction of the virtual river surface in each rendering period, thereby controlling the virtual river surface to produce the realistic deformation corresponding to a sunny day. The initial rendering parameter may be the altitude of the virtual river surface on a rainy day. In one case, if the rainy day lasts for a short time, the virtual river surface only rises to a height a. At this time, the initial virtual parameter may be height a. In another case, if the rainy day lasts for a long time, the virtual river surface rises to the maximum height b. At this time, the initial virtual parameter may be height b.

Optionally, the method according to the present disclosure may further include: if the current deformation of the first target virtual object reaches a second preset threshold, controlling the first target virtual object to maintain the current deformation unchanged.

Similarly, when the current deformation of the first target virtual object reaches a second preset threshold, the first target virtual object may be controlled to stop deforming. That is, the current deformation remains unchanged. The second preset threshold is smaller than the first preset threshold. For example, on a sunny day, when the retreat of the virtual river surface reaches the second preset threshold, the virtual river surface may be controlled to stop deforming, instead of continuing to decline indefinitely.

Based on the deformation that occurs under the sunny weather, in the above steps, when the deformation of the first target virtual object reaches a preset threshold, the interaction parameter of the first target virtual object is modified, thereby changing the interactable state of the first target virtual object. This may include: when the water on the virtual river surface drops to the preset height, the interactable state of the virtual river surface may be changed to be a passable area. Due to the continuous lowering down of the virtual river surface, in this case, virtual characters or virtual carriers may pass through the virtual river surface. That is, the interactable state of the virtual river surface becomes a passable area. At this time, referring to the above embodiment, this may be achieved by deleting the added virtual barrier model.

Optionally, in some embodiments, the target virtual object may include: a first target virtual object and a second target virtual object. The method according to the present disclosure may further include: when the deformation of the first target virtual object reaches a preset threshold, the interaction parameter of the second target virtual object is modified, thereby changing the interactable state of the second target virtual object.

Optionally, the second target virtual object may be a virtual object disposed on the first target virtual object, and the interactable state of the second target virtual object may change with the deformation of the first target virtual object. Similarly, the changing of the interactable state of the second target virtual object may comprise: setting the second target virtual object as a passable area or an unpassable area.

Optionally, the target weather may include: a rainy day; the second target virtual object may be: a virtual bridge; and the variation of the rendering parameter may include: an altitude increment.

In an embodiment, the first target virtual object may still be a virtual river surface. Similar to the deformation analysis in which the target weather is a rainy day and the first target virtual object is a virtual river surface, when the target virtual object includes both a virtual river surface and a virtual bridge, the deformation of the virtual bridge may change with the change of the virtual river surface. The virtual bridge may be a virtual floating bridge disposed on the virtual river surface. That is, the virtual bridge is floating on the virtual river surface. The virtual bridge may rise as the virtual river surface rises, and may also fall as the virtual river surface falls. Similarly, on rainy days, the variation of the rendering parameter of the virtual bridge may include the altitude increment. Specifically, under the rainy weather, the specific deformation control of the virtual bridge may be understood with reference to the deformation control of the virtual river surface. It can be considered that the virtual bridge has the same deformation as the virtual river surface.

Optionally, the method according to the present disclosure may also include: if the current deformation of the second target virtual object reaches a third preset threshold, controlling the second target virtual object to maintain the current deformation unchanged.

Optionally, the third preset threshold may be the same as the above-mentioned first preset threshold. When the current deformation of the first target virtual object reaches the first preset threshold, it may also be considered that the current deformation of the second target virtual object has reached the third preset threshold. At this time, the second target virtual object stops deforming.

Optionally, based on the generation of the above deformation, when the virtual floating bridge rises to the third preset threshold, that is, when the deformation stops, the interactable state of the virtual floating bridge may be changed to be a passable state. Since the virtual floating bridge continues to rise along with the virtual river surface at this time, the virtual floating bridge may be spread out straight on the virtual river surface, and virtual characters or virtual carriers may pass through the virtual floating bridge.

It should be noted that in some cases, the second target virtual object may be a virtual stone bridge, such as a stone bridge over a river, and the state thereof does not change with the deformation of the first target virtual object. However, when the deformation of the first target virtual object (that is, the virtual river surface) reaches the first preset threshold under the rainy weather, the virtual river surface may submerge the virtual stone bridge. At this time, the virtual stone bridge will be unable to pass, and the interactable state of the second target virtual object may be changed to be an unpassable area. When the virtual river surface drops to a point where the deformation reaches the second preset threshold on a sunny day, the virtual stone bridge is exposed on the virtual river surface. At this time, the virtual stone bridge will be passable, and the interactable state of the second target virtual object may be changed to be a passable area.

Optionally, the target weather may also include: a sunny day; the second target virtual object may be: a virtual bridge; and the variation of the rendering parameter may include: an altitude reduction.

Similarly, on a sunny day, as the virtual river surface gradually recedes, the virtual bridge will gradually sink, and the corresponding variation of the rendering parameter may be the altitude reduction.

Optionally, the method according to the present disclosure may further include: if the current deformation of the second target virtual object reaches a fourth preset threshold, controlling the second target virtual object to maintain the current deformation unchanged.

In an embodiment, different from the deformation of the first target virtual object, when the deformation of the first target virtual object reaches the second preset threshold on a sunny day, the current deformation of the second target virtual object reaches the fourth preset threshold. At this time, the fourth preset threshold is not equal to the second preset threshold. Since the virtual floating bridge has certain gravity, when the virtual river surface drops, the fourth preset threshold reached by the virtual floating bridge causes the virtual floating bridge to possibly assume a U-shaped state and stop deforming.

At this time, because the virtual floating bridge is partially submerged and is unpassable, the interactable state of the second target virtual object may be changed to be an unpassable area.

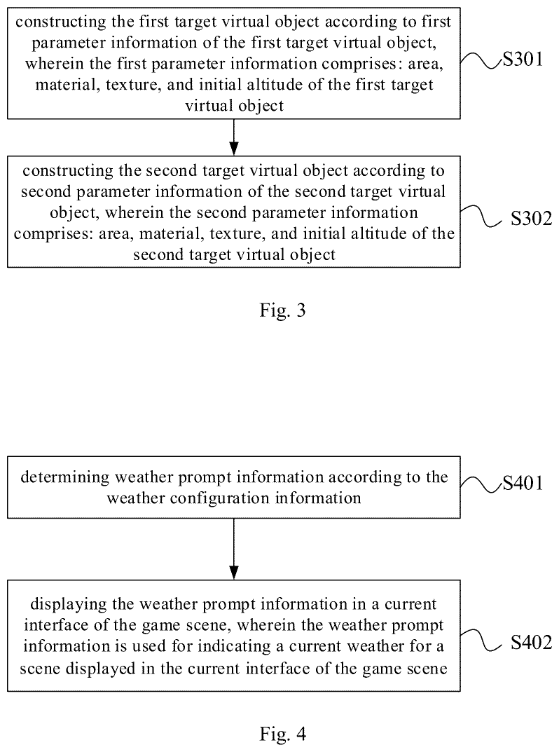

FIG. 3 is a schematic flowchart 3 of a method for displaying a game scene provided by an embodiment of the present disclosure. Optionally, in step S103, before the rendering parameter of the target virtual object is adjusted according to the deformation parameter, thereby controlling the target virtual object to deform in the game scene, the method according to the present disclosure may also include the following contents.

S301, the first target virtual object is constructed according to the first parameter information of the first target virtual object. The first parameter information includes: the area, material, texture, and initial altitude of the first target virtual object.

Optionally, the first target virtual object may be a virtual river surface. The water surface size of the virtual river surface may be determined according to the area size of the virtual river surface. The first target virtual object may be constructed according to the color, material, property, initial altitude, etc. of the virtual river surface. The material may represent whether the river surface is a swamp, sludge, or ordinary water surface, etc. The property may represent whether the river surface is flowing. The initial altitude may refer to the initial height of the first target virtual object.

S302, the second target virtual object is constructed according to the second parameter information of the second target virtual object. The second parameter information includes: the area, material, texture, and initial altitude of the second target virtual object.

Similar to the parameter information of the first target virtual object, the area of the second target virtual object may refer to the deck area of the virtual bridge; the material may refer to the structural material of the virtual bridge, such as a stone bridge, a bamboo bridge, etc.; the texture may refer to the surface texture of the virtual bridge; and the initial altitude may refer to the initial setting height of the virtual bridge.

It should be noted that in the present disclosure, as an example for illustration, the target weather is a rainy or sunny day, and the target virtual object is a virtual river surface and a virtual bridge. The deformation control of the target virtual object under the target weather is given in detail. But, the method may be also used in various game scenarios, where the target weather is any weather, such as a snowy, hailing, or foggy day, etc., and the target virtual object is a virtual building, virtual grassland, etc. With respect to the control over the deformation of the target virtual object under different target weathers, the control over the corresponding deformation parameter may be achieved.

FIG. 4 is a schematic flowchart 4 of a method for displaying a game scene provided by an embodiment of the present disclosure. Optionally, the method according to the present disclosure may also include the following contents.

S401, the weather prompt information is determined according to the weather configuration information.

In some embodiments, the current weather for the game scene may also be determined based on the weather configuration information. The server may read the weather configuration information, and send the current weather to the terminal device. Alternatively, the terminal device may determine the current weather based on the locally stored weather configuration information. Further alternatively, the terminal device may read the current weather from the weather application.

S402, the weather prompt information is displayed in the current interface of the game scene. The weather prompt information is used for indicating the current weather for the scene displayed in the current interface of the game scene.

Optionally, the preset weather prompt information may be displayed in the current interface of the game scene, so as to intuitively remind the game player of the current weather. The current interface of the game scene may refer to the game interface that can be displayed in the current terminal interface, which may be a part of the game scene. The current weather displayed may also be the current weather for a part of the scene displayed in the current interface of the game scene. This helps the game player to grasp the weather for the current game scene in real time.

In summary, the method for displaying a game scene provided by an embodiment of the present disclosure includes: acquiring the weather configuration information for the game scene, and setting the target weather for the game scene according to the weather configuration information; acquiring the deformation parameter of the target virtual object in the game scene under the target weather; adjusting the rendering parameter of the target virtual object according to the deformation parameter, thereby controlling the target virtual object to deform in the game scene. According to the proposed method, the deformation parameter is acquired of the target virtual object in the game scene under the target weather, and the rendering parameter of the target virtual object is adjusted through the deformation parameter, thereby achieving the deformation control of the target virtual object under the target weather. Since the rendering parameter of the target virtual object may be adjusted in real time through the deformation parameter, the precise control over the deformation of the target virtual object may be achieved. This helps to achieve the realistic simulation of the deformation effect, enrich the performance of the game scene, and improve the player's gaming experience.

In the following, the apparatus, device, storage medium, etc., used to perform the method for displaying a game scene provided by the present disclosure, are illustrated. Reference may be made to the above specific implementation process and technical effects, and will not be described again below.

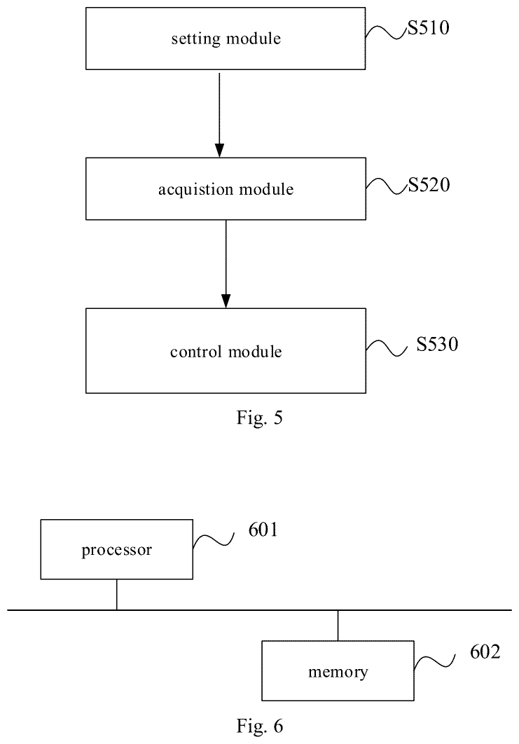

FIG. 5 is a schematic diagram of an apparatus for displaying a game scene provided by an embodiment of the present disclosure. The functions implemented by the apparatus for displaying a game scene correspond to the steps performed by the above method. The apparatus may be understood as the above-mentioned terminal device or the server, or the processor of the server, and may also be understood as a component independent of the above-mentioned server or processor that implements the functions of the present disclosure under the control by the server. As shown in FIG. 5, the device may include: a setting module 510, an acquisition module 520, and a control module 530.

The setting module 510 is configured to acquire the weather configuration information for the game scene, and set the target weather for the game scene according to the weather configuration information.

The acquisition module 520 is configured to acquire the deformation parameter of the target virtual object in the game scene under the target weather.

The control module 530 is configured to adjust the rendering parameter of the target virtual object according to the deformation parameter, thereby controlling the target virtual object to deform in the game scene.

Optionally, the acquisition module 520 is specifically configured to acquire the weather parameter of the target weather; and determine the deformation parameter according to the weather parameter. The deformation parameter includes the unit movement distance.

Optionally, the weather parameter includes: the weather duration and/or the weather measurement value.

Optionally, the deformation parameter of the target virtual object in the game scene under the target weather includes: the unit movement distance.

The control module 530 is specifically configured to: determine the rendering period and the variation of the rendering parameter in each rendering period based on the unit movement distance, where the unit movement distance is determined based on the weather parameter of the target weather, and the weather parameter includes: the weather duration and/or the weather measurement value; and according to the rendering period, ultilize the variation of the rendering parameter in the rendering period for controlling the target virtual object to deform in the game scene.

Optionally, the target virtual object includes: a first target virtual object; the apparatus further includes: a modification module.

The modification module is configured to modify the interaction parameter of the first target virtual object when the deformation of the first target virtual object reaches a preset threshold, thereby changing the interactable state of the first target virtual object.

Optionally, changing the interactable state of the first target virtual object includes: setting the first target virtual object as a passable area or an unpassable area.

Optionally, the target weather includes: a rainy day; the first target virtual object is: a virtual river surface; and the variation of the rendering parameter includes: the altitude increment.

Optionally, the control module 530 is further configured to control the first target virtual object to maintain the current deformation unchanged, if the current deformation of the first target virtual object reaches the first preset threshold.

Optionally, the target weather includes: a sunny day; the first target virtual object is: a virtual river surface; and the variation of the rendering parameter includes: the altitude reduction.

Optionally, the control module 530 is further configured to control the first target virtual object to maintain the current deformation unchanged, if the current deformation of the first target virtual object reaches the second preset threshold.

Optionally, the target virtual object includes: a first target virtual object and a second target virtual object.

The modification module is further configured to modify the interaction parameter of the second target virtual object when the deformation of the first target virtual object reaches a preset threshold, thereby changing the interactable state of the second target virtual object.

Optionally, changing the interactable state of the second target virtual object includes: setting the second target virtual object as a passable area or an unpassable area.

Optionally, the target weather includes: a rainy day; the second target virtual object is: a virtual bridge; and the variation of the rendering parameter includes: the altitude increment.

Optionally, the control module 530 is further configured to control the second target virtual object to maintain the current deformation unchanged, if the current deformation of the second target virtual object reaches the third preset threshold.

Optionally, the target weather includes: a sunny day; the second target virtual object is: a virtual bridge; and the variation of the rendering parameter includes: the altitude reduction.

Optionally, the control module 530 is further configured to control the second target virtual object to maintain the current deformation unchanged, if the current deformation of the second target virtual object reaches the fourth preset threshold.

Optionally, the apparatus further includes: a construction module.

The construction module is configured to: construct the first target virtual object according to the first parameter information of the first target virtual object, where the first parameter information includes the area, material, texture, and initial altitude of the first target virtual object; construct the second target virtual object according to the second parameter information of the second target virtual object, where the second parameter information includes the area, material, texture, and initial altitude of the second target virtual object.

Optionally, the apparatus further includes: a determination module and a display module.

The determination module is configured to determine the weather prompt information based on the weather configuration information.

The display module is configured to display the weather prompt information in the current interface of the game scene, where the weather prompt information is used for indicating the current weather for the scene displayed in the current interface of the game scene.

The above apparatus is used to perform the method provided in the foregoing embodiments. The implementation principles and technical effects thereof are similar and will not be described again here.

The above modules may be one or more integrated circuits configured to implement the above methods, such as: one or more application specific integrated circuits (ASICs for short), or one or more microprocessors (or digital signal processors, DSP for short), or one or more Field Programmable Gate Array (FPGA for short), etc. For another example, when one of the above modules is implemented in the form of a processing element scheduling program codes, the processing element may be a general-purpose processor, such as a central processing unit (CPU for short) or other processors that can call the program codes. For another example, these modules may be integrated together and implemented in the form of a system-on-a-chip (SOC for short).

The above-mentioned modules may be connected or communicate with each other via wired connections or wireless connections. Wired connections may include metal cables, fiber optic cables, hybrid cables, etc., or any combination thereof. Wireless connections may include connections via LAN, WAN, Bluetooth, ZigBee, or NFC, or any combination thereof. Two or more modules may be combined into a single module, and any one module may be divided into two or more units. Those skilled in the art can clearly understand that for the convenience and simplicity of description, the specific working processes of the system and apparatus described above may be referred to the corresponding processes in the method embodiments, and will not be described again in the present disclosure.

It should be noted that the above modules may be one or more integrated circuits configured to implement the above methods, for example: one or more Application Specific Integrated Circuits (ASICs for short), or one or more micro-processors (or Digital Signal Processor, DSP for short), or one or more Field Programmable Gate Array (FPGA for short), etc. For another example, when one of the above modules is implemented in the form of a processing element scheduling program codes, the processing element may be a general-purpose processor, such as a central processing unit (CPU for short) or other processors that can call the program codes. For another example, these modules may be integrated together and implemented in the form of a system-on-a-chip (SOC).

FIG. 6 is a schematic structural diagram of an electronic device provided by an embodiment of the present disclosure. The device may include: a processor 601 and a memory 602.

The memory 602 is configured to store programs, and the processor 601 calls the programs stored in the memory 602 to perform the above method embodiments. The specific implementation methods and technical effects are similar and will not be described again here.

The memory 602 stores program codes. When the program codes are executed by the processor 601, the processor 601 is caused to perform various steps in each of the methods according to various exemplary embodiments of the present disclosure as described in the “Example Method” section of the present specification.

The processor 601 may be a general-purpose processor, such as a central processing unit (CPU), a digital signal processor (DSP), an application specific integrated circuit (ASIC), or a field programmable gate array (FPGA), or other programmable logic devices, discrete gate or transistor logic devices, and discrete hardware components, that can implement or perform the methods, steps, and logical block diagrams disclosed in the embodiments of the present disclosure. A general-purpose processor may be a microprocessor or any conventional processor, etc. The steps of the methods disclosed in conjunction with the embodiments of the present disclosure may be directly implemented as being executed by a hardware processor, or executed using a combination of hardware and software modules in the processor.

As a non-volatile computer-readable storage medium, the memory 602 may be used to store non-volatile software programs, non-volatile computer executable programs and modules. The memory may include at least one type of storage medium, such as flash memory, hard disk, multimedia card, card-type memory, random access memory (RAM), static random access memory (SRAM), Programmable Read Only Memory (PROM), Read Only Memory (ROM), Electrically Erasable Programmable Read-Only Memory (EEPROM), magnetic memory, disk, CDs etc. Memory is, but is not limited to, any other medium that can be used to carry or store desired program codes in the form of instructions or data structures and that can be accessed by a computer. The memory 602 in the embodiments of the present disclosure may also be a circuit or any other device capable of realizing a storage function, and is used to store program instructions and/or data.

Optionally, the present disclosure also provides a program product, such as a computer-readable storage medium, including a program. When the program is executed by a processor, the above method embodiments are performed.

In several embodiments provided by the present disclosure, it should be understood that the disclosed apparatus and methods may be implemented in other ways. For example, the apparatus embodiments described above are only illustrative. For example, the division of the units is only a logical function division. In actual implementations, there may be other division ways. For example, multiple units or components may be combined or may be integrated into another system, or some features may be ignored, or not implemented. On the other hand, the coupling or direct coupling or communication connection between each other as shown or discussed may be through some interface, and the indirect coupling or communication connection among the devices or units may be in electrical, mechanical or other forms.

The units described as separate components may or may not be physically separated, and the components shown as units may or may not be physical units. That is, they may be located in one place, or they may be distributed across multiple network units. Some or all of the units may be selected according to actual needs, so as to achieve the purpose of the solution according to embodiments of the present disclosure.

In addition, each functional unit in various embodiments of the present disclosure may be integrated into one processing unit, or each unit may exist physically alone, or two or more units may be integrated into one unit. The above integrated unit may be implemented in the form of hardware or in the form of hardware plus software functional units.

The above-mentioned integrated unit implemented in the form of a software functional unit may be stored in a computer-readable storage medium. The above-mentioned software functional unit is stored in a storage medium, and includes a number of instructions to cause a computer device (which may be a personal computer, a server, or a network device, etc.) or a processor to perform some steps of the method in the various embodiments of the present disclosure. The aforementioned storage media include various media that may store program codes, such as: U disk, mobile hard disk, read-only memory (abbreviation: ROM), random access memory (abbreviation: RAM), magnetic disk or optical disk, etc.

1. A method for displaying a game scene, comprising:
acquiring weather configuration information for the game scene, and setting a target weather for the game scene according to the weather configuration information;
acquiring a deformation parameter of a target virtual object in the game scene under the target weather; and
adjusting a rendering parameter of the target virtual object according to the deformation parameter, thereby controlling the target virtual object to deform in the game scene.

2. The method according to claim 1, wherein said acquiring the deformation parameter of the target virtual object in the game scene under the target weather comprises:
acquiring a weather parameter of the target weather; and
determining the deformation parameter according to the weather parameter, wherein the deformation parameter comprises a unit movement distance.

3. The method according to claim 2, wherein the weather parameter comprises: a weather duration and/or a weather measurement value.

4. The method according to claim 2, wherein said adjusting the rendering parameter of the target virtual object according to the deformation parameter, thereby controlling the target virtual object to deform in the game scene, comprises:
determining, according to the unit movement distance, a rendering period and a variation of the rendering parameter in each rendering period; and
ultilizing, according to the rendering period, the variation of the rendering parameter in the rendering period to control the target virtual object to deform in the game scene.

5. The method according to claim 4, wherein
the target virtual object comprises: a first target virtual object; and
the method further comprises:
when a deformation of the first target virtual object reaches a preset threshold, modifying an interaction parameter of the first target virtual object, thereby changing an interactable state of the first target virtual object.

6. The method according to claim 5, wherein said changing the interactable state of the first target virtual object comprises:
setting the first target virtual object as a passable area or an unpassable area.

7. The method according to claim 6, wherein
the target weather comprises: a rainy day;
the first target virtual object is: a virtual river surface; and
the variation of the rendering parameter comprises: an altitude increment.

8. The method according to claim 7, wherein the method further comprises:
if a current deformation of the first target virtual object reaches a first preset threshold, controlling the first target virtual object to maintain the current deformation unchanged.

9. The method according to claim 6, wherein
the target weather comprises: a sunny day;
the first target virtual object is: a virtual river surface; and
the variation of the rendering parameter comprises: an altitude reduction.

10. The method according to claim 9, wherein the method further comprises:
if a current deformation of the first target virtual object reaches a second preset threshold, controlling the first target virtual object to maintain the current deformation unchanged.

11. The method according to claim 4, wherein
the target virtual object comprises: a first target virtual object and a second target virtual object; and
the method further comprises:
when a deformation of the first target virtual object reaches a preset threshold, modifying an interaction parameter of the second target virtual object, thereby changing an interactable state of the second target virtual object.

12. The method according to claim 11, wherein said changing the interactable state of the second target virtual object comprises:
setting the second target virtual object as a passable area or an unpassable area.

13. The method according to claim 12, wherein
the target weather comprises: a rainy day;
the second target virtual object is: a virtual bridge; and
the variation of the rendering parameter comprises: an altitude increment.

14. The method according to claim 13, wherein the method further comprises:
if a current deformation of the second target virtual object reaches a third preset threshold, controlling the second target virtual object to maintain the current deformation unchanged.

15. The method according to claim 12, wherein
the target weather comprises: a sunny day;
the second target virtual object is: a virtual bridge; and
the variation of the rendering parameter comprises: an altitude reduction.

16. The method according to claim 15, wherein the method further comprises:
if a current deformation of the second target virtual object reaches a fourth preset threshold, controlling the second target virtual object to maintain the current deformation unchanged.

17. The method according to claim 5, wherein, before adjusting the rendering parameter of the target virtual object according to the deformation parameter, thereby controlling the target virtual object to deform in the game scene, the method further comprises:
constructing the first target virtual object according to first parameter information of the first target virtual object, wherein the first parameter information comprises:
area, material, texture, and initial altitude of the first target virtual object; and
constructing the second target virtual object according to second parameter information of the second target virtual object, wherein the second parameter information comprises: area, material, texture, and initial altitude of the second target virtual object.

18. The method according to claim 1, wherein the method further comprises:
determining weather prompt information according to the weather configuration information; and
displaying the weather prompt information in a current interface of the game scene, wherein the weather prompt information is used for indicating a current weather for a scene displayed in the current interface of the game scene.

19. (canceled)

20. An electronic device, compressing: a processor, a storage medium, and a bus, wherein
the storage medium stores program instructions executable by the processor; and
when the electronic device is running, the processor and the storage medium communicate through the bus, and the processor executes the program instructions to perform steps of a method for displaying a game scene, comprising:
acquiring weather configuration information for the game scene, and setting a target weather for the game scene according to the weather configuration information;
acquiring a deformation parameter of a target virtual object in the game scene under the target weather; and
adjusting a rendering parameter of the target virtual object according to the deformation parameter, thereby controlling the target virtual object to deform in the game scene.

21. A computer-readable storage medium, wherein a computer program is stored on the storage medium, and when run by a processor, the computer program performs steps of a method for displaying a game scene, comprising:
acquiring weather configuration information for the game scene, and setting a target weather for the game scene according to the weather configuration information;
acquiring a deformation parameter of a target virtual object in the game scene under the target weather; and
adjusting a rendering parameter of the target virtual object according to the deformation parameter, thereby controlling the target virtual object to deform in the game scene.
